(19) United States
(12) Patent Application Publication
(10) Pub. No.: US 2014/0126865 A1
(43) Pub. Date: May 8, 2014

(54) Cable Structure for Underwater Equipment

(71) Applicants: YOU-FENG COMPANY LIMITED, New Taipei City (TW); CHIENG MING INDUSTRIES CO., LTD., New Taipei City (TW)

(72) Inventor: CHIN-YUNG CHANG, New Taipei City (TW)

(73) Assignees: CHIENG MING INDUSTRIES CO., LTD., New Taipei City (TW); YOU-FENG COMPANY LIMITED, New Taipei City (TW)

(21) Appl. No.: 13/672,653

(22) Filed: Nov. 8, 2012

(51) Int. Cl. G02B 6/44; H01B 3/47; H01B 3/30; H01B 11/22; H01B 7/28

(52) U.S. Cl. CPC G02B 6/4494; H01B 11/22; H01B 7/28; H01B 3/302; H01B 3/47
USPC 385/101; 385/100; 174/110 R; 174/110 SR

(57) ABSTRACT

A cable structure for underwater equipment is disclosed, which comprises a waterproof layer, a tension-resistant layer, a buoyant layer, and a communication thread. The tension-resistant layer is enveloped in the waterproof layer. The buoyant layer is enveloped in the tension-resistant layer. The communication thread is enveloped in the buoyant layer. In use, the waterproof layer can protect the communication thread from contacting with water. The tension-resistant layer can enhance the tensile strength of the cable structure, so that the cable structure can be protected from damages upon being pulled. The buoyant layer can provide buoyancy for the cable structure, so that the cable structure can avoid excessive cable being submerged in the water, so that entwining or entangling of the submerged cable section can be prevented. Accordingly, the present invention is a useful contrivance that can avoid cable entanglement and has a tension-resistant capability.

### (a) TECHNICAL FIELD OF THE INVENTION

The present invention relates to a cable structure and, more particularly, to a cable structure for underwater equipment, which tends to float on water for preventing the submerged cable from entanglement and has a tension-resistant capability.

### (b) DESCRIPTION OF THE PRIOR ART

Generally, conventional cables are fixed at intervals to external installations, such as electric poles, so that the support strength of the cables can be increased, and thus the cables can be prevented from deviating their original positions upon being pulled, and the devices attached thereto can be protected from being damaged.

As to conventional cables for use in underwater equipment, since the cables should have a capability to be moved in horizontal direction (including back, forth, right, and left direction) and in vertical direction, they should have a sufficient length of cable available for being submerged in the water, so that the underwater equipment can change position in wide range. However, a cable with excessive length is prone to be entwined or entangled due to water flow or movement of the underwater equipment. For example, the underwater equipment may be entangled with the cable connected thereto, or the cables may have friction with the reefs, thereby causing damages to the cables. Thus, there is a need for improvement.

In view of the foregoing, based on the long-term experiences on the related works and constant tests and modifications on cable structures, the applicant has contrived a novel cable structure that has a tendency to float on water, so that the cable structure can be prevented from entanglement, and has an excellent tensile strength.

### SUMMARY OF THE INVENTION

The primary object of the present invention is to provide a cable structure for underwater equipment, which tends to float on water, so that the cable structure can avoid excessive cable section being submerged in water, so that the cable structure can be prevented from entwining or entanglement.

Another object of the present invention is to provide a cable structure for underwater equipment, which has a tension-resistant capability, so that the cable structure can be protected from damages upon being pulled.

To achieve the above object, the present invention provides a cable structure, which comprises at least one waterproof layer, at least one tension-resistant layer, at least one buoyant layer, and at least one communication thread, wherein the tension-resistant layer is enveloped in the waterproof layer; the buoyant layer is enveloped in the tension-resistant layer; the communication thread is enveloped in the buoyant layer. The communication thread can be a fiber optic line or an electrical wire, or a combination of the fiber optic line and the electrical wire. The buoyant layer can be made of thermoplastic rubber (TPR) and hollow glass micro-spheres. The tension-resistant layer can be made of aromatic polyamide fiber material or polyethylene polymer fiber material, or a combination of the two materials. The waterproof layer can be made of thermoplastic polyurethane material. In use, the waterproof layer would be the outmost layer of the cable structure and can protect the communication thread from contacting with water. The tension-resistant layer can enhance the tensile strength of the cable structure, so that the cable structure can be protected from damages upon being pulled. The buoyant layer can provide buoyancy for the cable structure, so that the cable structure has a tendency to float on water, so that the cable submerged in the water can keep at a minimum length. As a result, the underwater equipment can draw the required length of cable into the water when the underwater equipment moves, so that the cable structure can avoid excessive cable being submerged in the water, so that entwining or entangling of the submerged cable section can be prevented. With the present invention, the problems of entwining or entangling occurred in conventional cables can be avoided.

Other objects, advantages, and novel features of the present invention will become more apparent from the following detailed description when taken in conjunction with the accompanying drawings.

### BRIEF DESCRIPTION OF THE DRAWINGS

FIG. 1 shows a schematic 3-dimensional view of one embodiment of the present invention.

FIG. 2 shows a schematic sectional view of the embodiment of the present invention.

FIG. 3 shows a schematic working view of the embodiment of the present invention.

FIG. 4 shows a schematic working view of another embodiment of the present invention.

FIG. 5 shows a schematic sectional view of a further embodiment of the present invention.

### DETAILED DESCRIPTION OF THE PREFERRED EMBODIMENTS

To allow the above objects and effectiveness of the present invention to be fully understood, embodiments using the technical means and principles of the present invention will be illustrated in detail, with reference to the accompanying drawings, in the following.

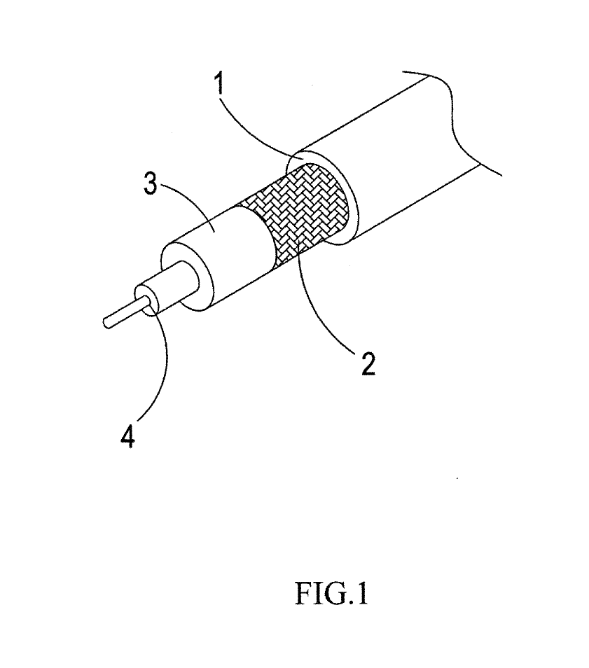

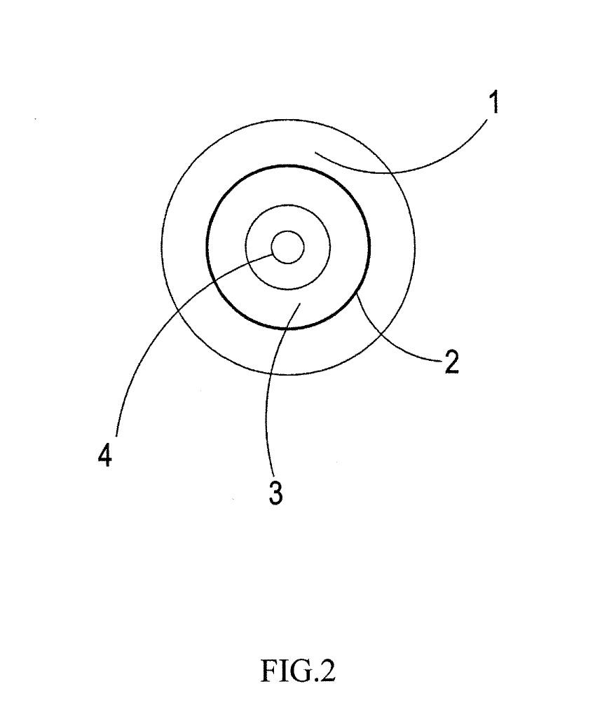

Referring to FIGS. 1 and 2, a cable structure for underwater equipment according to one embodiment of the present invention is disclosed, which comprises at least one waterproof layer 1, at least one tension-resistant layer 2, at least one buoyant layer 3, and at least one communication thread 4. The waterproof layer 1 can be made of thermoplastic polyurethane material. The tension-resistant layer 2 is enveloped in the waterproof layer 1. The tension-resistant layer 2 can be made of aromatic polyamide fiber material or polyethylene polymer fiber material. Alternatively, the tension-resistant layer 2 can be made of a combination of aromatic polyamide fiber material and polyethylene polymer fiber material. The buoyant layer 3 is enveloped in the tension-resistant layer 2. The buoyant layer 3 can be made of thermoplastic rubber (TPR) and hollow glass micro-spheres, wherein the ratio of the thermoplastic rubber to the hollow glass micro-spheres is about 10:5. The communication thread 4 is enveloped in the buoyant layer 3. The communication thread 4 can be a fiber optic line or an electrical wire. Alternatively, the communication thread 4 may include a fiber optic line and an electrical wire. All materials respectively for the waterproof layer 1, the tension-resistant layer 2, the buoyant layer 3, and the communication thread 4 are made from a biodegradable material, which makes the present invention more environmentally friendly. The above embodiment is not limited to the form being shown in the figures. It can have other forms to achieve the same purpose.

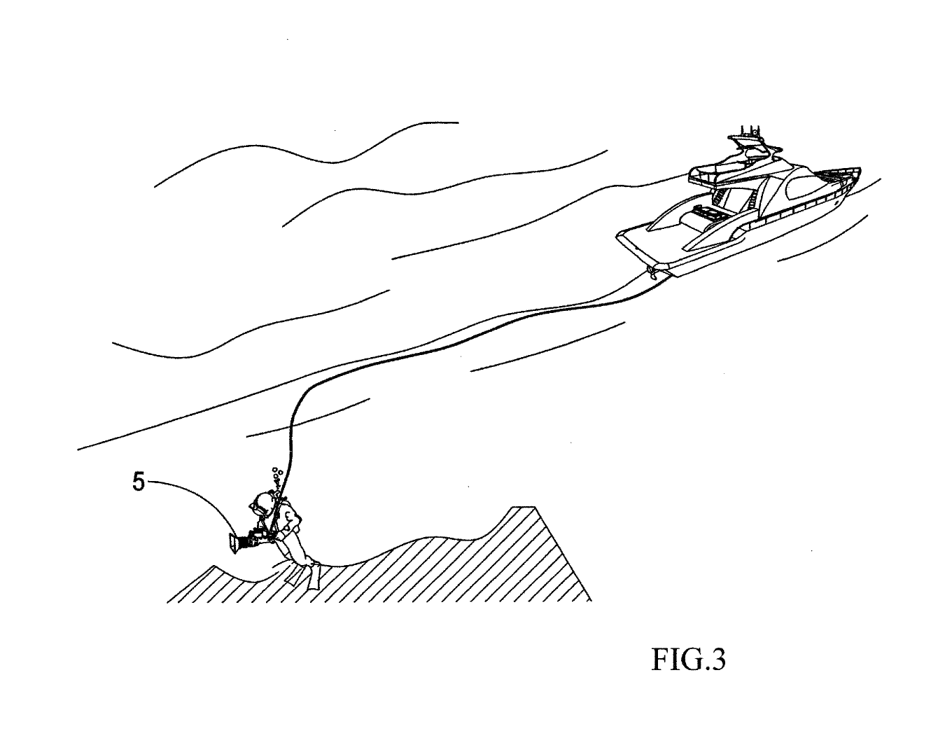

The operation principles of the present invention will be illustrated in detail, with reference to FIGS. 1 to 3, in the following. It is clearly seen in the figures, when the present invention is in use, since the waterproof layer 1 is the outmost layer of the cable structure of the present invention, it can protect the communication thread 4 from contacting with water. Also, the tension-resistant layer 2, being interposed between the waterproof layer 1 and the buoyant layer 3, can enhance the tensile strength of the cable structure, so that the cable structure can be protected from damages upon being pulled. Furthermore, since the density of the buoyant layer 3 is less than water, it can provide buoyancy for the cable structure, so that the cable structure has a tendency to float on water, no matter whether the cable structure is totally immersed in the water or partially floated above the surface of the water. Furthermore, one end of the cable structure can be connected to the underwater equipment 5, and thus the end section of the cable structure would be submerged in the water. Due to the buoyancy of the buoyant layer 3 of the cable structure, the excessive submerged section of the cable structure can be moved to the water surface. Therefore, the cable submerged in the water can keep at a minimum length. As a result, the underwater equipment 5 can draw the required length of cable into the water when the underwater equipment 5 moves, so that the cable structure can avoid excessive cable being submerged in the water, so that entwining or entangling of the submerged cable section can be prevented.

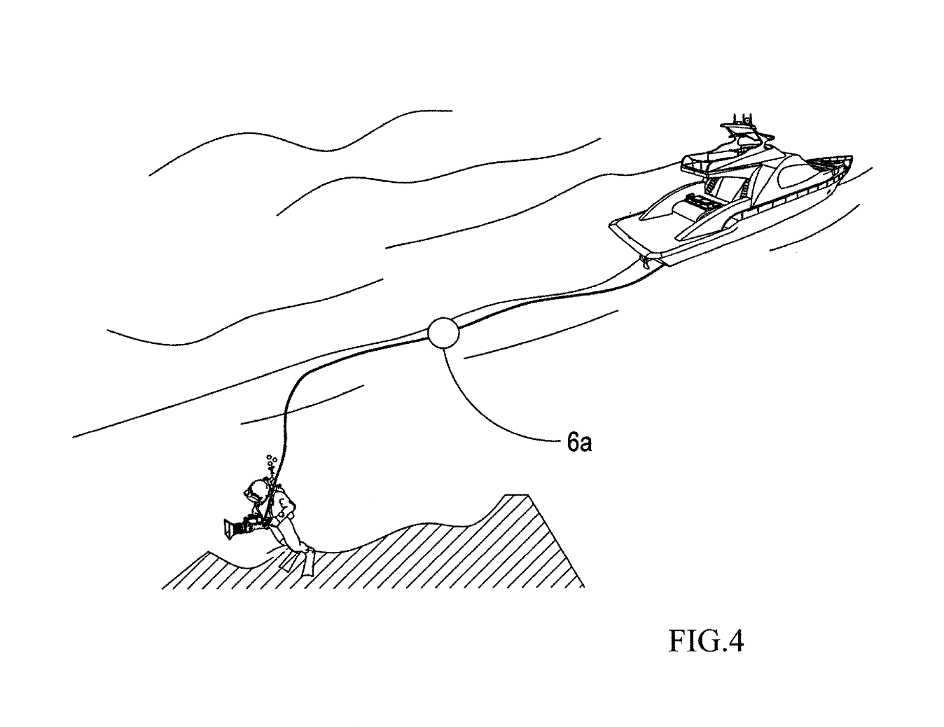

FIG. 4 shows another embodiment of the present invention. It is clearly seen in the figure that the cable structure is further provided with at least one positioning device 6a, so that the position of the cable structure can be ensured.

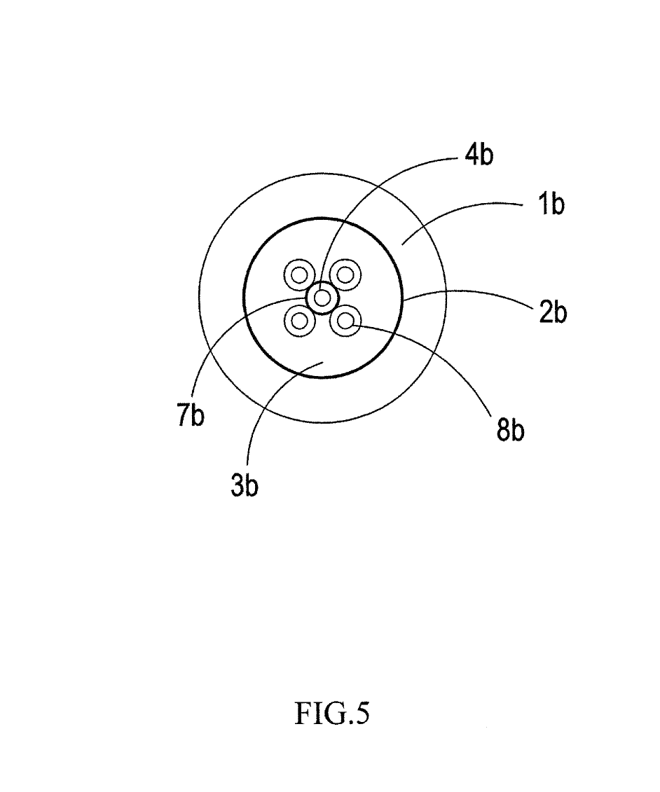

FIG. 5 shows a further embodiment of the present invention. It is clearly seen in the figure that the embodiment comprises at least one waterproof layer 1b, at least one tension-resistant layer 2b enveloped in the waterproof layer 1b, at least one buoyant layer 3b enveloped in the tension-resistant layer 2b, and at least one communication thread 4b enveloped in the buoyant layer 3b. Furthermore, a second tension-resistant layer 7b can be interposed between the previous communication thread 4b and the buoyant layer 3b, so that the communication thread 4b of the cable structure can be further protected. Still furthermore, a second communication thread 8b can be provided in the buoyant layer 3b and located opposite to the previous communication thread 4b with respect to the second tension-resistant layer 7b, so that the application availability of the cable structure can be increased. The above embodiment is not limited to the form being shown in the figure. It can have other forms to achieve the same purpose.

As a summary, the present invention has the following advantages:

1. With the buoyant layer 3, the cable structure of the present invention has a tendency to float on water, thereby preventing the submerged cable from being entwined or entangled.

2. With the tension-resistant layer 2, the tensile strength of the cable structure of the present invention can be increased.

3. The cable structure can be made of biodegradable materials, which makes the present invention more environmentally friendly.

Accordingly, the present invention is a useful contrivance.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A cable structure for underwater equipment, comprising:
at least one waterproof layer;
at least one tension-resistant layer enveloped in said waterproof layer;
at least one buoyant layer enveloped in said tension-resistant layer; and
at least one communication thread enveloped in said buoyant layer.

2. A cable structure for underwater equipment as claimed in claim 1, wherein said waterproof layer is made of thermoplastic polyurethane material.

3. A cable structure for underwater equipment as claimed in claim 1, wherein said tension-resistant layer is made of aromatic polyamide fiber material or polyethylene polymer fiber material.

4. A cable structure for underwater equipment as claimed in claim 1, wherein said tension-resistant layer is made of a combination of aromatic polyamide fiber material and polyethylene polymer fiber material.

5. A cable structure for underwater equipment as claimed in claim 1, wherein said buoyant layer is made of thermoplastic rubber and hollow glass micro-spheres, the ratio of said thermoplastic rubber to said hollow glass micro-spheres being about 10:5.

6. A cable structure for underwater equipment as claimed in claim 1, wherein said communication thread is a fiber optic line or an electrical wire.

7. A cable structure for underwater equipment as claimed in claim 1, wherein said communication thread is a combination of a fiber optic line and an electrical wire.

8. A cable structure for underwater equipment as claimed in claim 1, wherein the cable structure is provided with at least one positioning device.

9. A cable structure for underwater equipment as claimed in claim 1, wherein a second tension-resistant layer is interposed between the previous communication thread and said buoyant layer.

10. A cable structure for underwater equipment as claimed in claim 9, wherein a second communication thread is provided in said buoyant layer and located opposite to the previous communication thread with respect to said second tension-resistant layer.
